(19) United States
(12) Patent Application Publication
(10) Pub. No.: US 2015/0058481 A1
(43) Pub. Date: Feb. 26, 2015

(54) METHOD & APPARATUS FOR MEASURING POWER, BANDWIDTH AND MONITORING THE OPERATION OF A NETWORK INFRASTRUCTURE FROM ANOTHER NETWORK INFRASTRUCTURE

(71) Applicants: BRUCE D. MILLER, NORTH READING, MA (US); CHUBA N. UDOKWU, ACTON, MA (US)

(72) Inventors: BRUCE D. MILLER, NORTH READING, MA (US); CHUBA N. UDOKWU, ACTON, MA (US)

(21) Appl. No.: 14/464,914

(22) Filed: Aug. 21, 2014

Related U.S. Application Data
(60) Provisional application No. 61/868,630, filed on Aug. 22, 2013.

(51) Int. Cl. H04L 12/26; G06F 11/30

(52) U.S. Cl. CPC H04L 43/0876; G06F 11/3058
USPC 709/224

(57) ABSTRACT

A method and apparatus for the measurement of power consumption, bandwidth usage and the monitoring of the operation of a network from another network. The primary intended application is for an enterprise network (1^{st} network) to be able to measure power and bandwidth of a small cell network (2^{nd} network) or networks that share some of the infrastructure with the enterprise network (1^{st}network). Power and network bandwidth usage per unit time can be measured and used to support interparty billing. In addition, the network and power infrastructure of the 2^{nd} network can be monitored by the 1^{st} network for operational integrity and performance. Sensitive information can be protected with strong encryption to allow it to use unsecured networking (and compute) facilities without exposure to unauthorized access.

### CROSS REFERENCE TO RELATED APPLICATIONS

This application claims the benefit under 35 U.S.C. §119(e) of U.S. Provisional Patent Application Ser. No. 61/868,630 entitled “METHOD & APPARATUS FOR MEASURING POWER, BANDWIDTH AND MONITORING THE OPERATION OF A NETWORK INFRASTRUCTURE FROM ANOTHER NETWORK INFRASTRUCTURE”, filed Aug. 22, 2013, the entire contents of which is incorporated by reference.

### FIELD OF THE INVENTION

The invention relates generally to communication networks. Specifically, the invention provides the means to monitor the power consumption, bandwidth usage and operation of a network from another network. The primary intended application is for an enterprise network (1^{st} network) to be able to measure the power and bandwidth of a small cell network (2^{nd} network) or other networks that share some of the infrastructure with the enterprise network (1^{st} network).

### BACKGROUND

The present invention includes aspects of a packet transmission apparatus, a power distribution apparatus, a communications system, and a management system and computer code.

The adoption of mobile communication has placed a strain on the existing macro cell infrastructure. The macro cell infrastructure consists of cell towers with their associated electronics including antennas, cellular radios, power electronics, nodeB/enodeB devices and backhaul complexes. Macro cells are designed to provide wide areas of coverage but are bandwidth limited by technology (GSM, LTE, LTE-advanced), distance to end devices and interference. Carriers are now aggressively deploying “small cells” to augment and offload the macro cell infrastructure. Small cells are compact and relatively inexpensive implementations of nodeB/enodeB, radio, power electronics and antenna subsystems that can be locally deployed to improve localized coverage and offload bandwidth from the macro-cell infrastructure. Deployments tend to be “ad hoc” with a carriers focusing on speed of deployment and capital costs; in an outdoor environment all that is typically needed is a mounting point, power, and a mechanism to get bandwidth (Ethernet typically) from the small cell to a point of backhaul (often point to point microwave links). Indoor deployments present additional challenges. Carriers are currently forced to build out dedicated infrastructure including power distribution and networking. This is quite expensive, disruptive and slows deployment. The focus of the invention is to provide a method and apparatus to facilitate small cell deployments in enterprise and private infrastructure by allowing the enterprise and private infrastructure to measure power and bandwidth utilization and use that information to bill carriers (or alternative second party) for usage.

### SUMMARY

Today, carriers are building overlay networks in multi-tenant and enterprise facilities for the purpose of deploying small cells to provide cellular and WiFi coverage. This approach is expensive and can significantly delay deployment velocity. It has been estimated that it can cost upwards of $2,000 to provide power distribution and network connectivity to a single small cell. In addition, construction of this type is extremely disruptive to ongoing activities. This is particularly so if a facility allows multiple carriers to deploy small cells within a facility.

A better model is to deploy small cells within the existing infrastructure with the ability to facilitate graceful co-residency. In order to do this, a mediation/measurement device can be deployed to provide network infrastructure demarcation and measure power and bandwidth usage. It is important for enterprises to be able to charge second parties for power and backhaul bandwidth usage to defray their costs and support deployment co-residency. These costs can be significant. A single small cell dissipating 65 w would dissipate 569 kw per year and cost $85.41 (at a cost of 0.15 cents/kw-hr). Bandwidth costs can similarly be significant.

It is critical for both the enterprise and the carrier to be able to provide a point of demarcation in the network to insure that reliable operation can be assured and faults can be isolated between the carrier and enterprise infrastructure. Historically, devices such as NIDs (network interface devices) have provided infrastructure demarcation between different portions of carrier infrastructure and between carrier and enterprise infrastructure; however, they are not designed to measure power and bandwidth usage between infrastructures; they are intended to provide points of fault isolation and serve as service assurance entities. As carriers deploy multiband small cells that incorporate WiFi and cellular to support voice and data traffic 3G, 4G . . . ) security becomes a concern Enterprise networks use WiFi access points as a primary mechanism to provide network connectivity to end devices. These devices are under the management and control of the enterprise network administration. Alternatively, a WiFi device that is deployed by a carrier is intended to collect traffic primarily for internet access and it is typically not under the control of the enterprise network administration. It is possible for sensitive traffic to be collected by the carrier deployed WiFi network and exposed inadvertently. In order to prevent this, encryption can be provided by the apparatus in order to protect sensitive data that is errantly sent off premise or sent between facilities or locally exposed.

Enterprises are best served by allowing multiple carriers to access their infrastructure. This allows the enterprise to be flexible in the service plans that are internally used and have flexibility in moving between carriers if so desired. The apparatus can support multiple attached access devices (ex: small cells) either homogenous from a single carrier or heterogeneously from multiple carriers. In the existing model, supporting multiple carriers requires each carrier to build dedicated overlay infrastructures which is expensive and quite disruptive. With the apparatus, multiple carriers can deploy within an enterprise network with very minor disruption and extremely low cost.

The invention is capable of deployment in either the carrier deployed network or the enterprise network and can be located either as a separate device or embedded in another device such as small cells or enterprise switches. A separate device implementation of the invention is described herein.

From a carrier perspective, the key needs are to be able to be able to deploy small cells expediently, at a low cost and to be able to effectively manage them. Expedient deployment mandates that carriers do not have to build out significant infrastructure and can leverage existing infrastructure. The cost of installation is significantly reduced as the carrier can utilize existing power and network facilities requiring a minimum of build out. In addition, the invention provides the ability to support distribution of network timing. Typically a NID (Network Interface Device) is placed between the carrier and the enterprise at the point of entry (access/aggregation network); however, if a small cell is deployed within the enterprise, there is no effective mechanism to isolate issues between the small cell and the enterprise. The invention provides a demarcation boundary for isolating issues between the two infrastructures in addition to providing power and bandwidth measurements.

FIG. 1 shows the existing network hierarchy between a multiplicity of mobile carriers and an enterprise. Mobile carriers 1 provide services based in their mobile serving office; the mobile serving office provides the anchoring technology for the macro and small cell infrastructures (gateways, mediation etc . . . ). The mobile serving office is connected through the internet 2 or dedicated facilities to a local carrier's serving office 3. The local carrier provides network connectivity to the end customer; in this case an enterprise 5. The local carrier's serving office 3 is connected to the enterprise via an access aggregation network 4. Within the enterprise 5 wireless infrastructure 6 is deployed as an access technology. Today, this would be a set of WiFi access points but the intent is to deploy carrier owned small cells or other access technology.

The inventive method provides the following processing functions in a packet transmission apparatus, a power distribution apparatus, a mediation apparatus, a power measurement apparatus, a bandwidth measurement apparatus and a security apparatus:
(a) A method for measuring packet usage and recording it for the purpose of one party charging for usage from another party.
(b) A method for providing power and measuring power for the purpose of one party charging for usage from another party.
(c) A method for distributing power over cats, cath infrastructure (or alternative copper facilities) to obviate the need for high voltage AC power distribution.
(d) A method for resynchronizing and/or distributing network timing.
(e) A method for providing network partitioning and management visibility.
(f) A method for providing strong encryption for sensitive information to allow it to use unsecured facilities without exposure to unauthorized access.

According to an embodiment, power measurement, bandwidth measurement and demarcation can be incorporated between a networking infrastructure (such as small cells) and another networking infrastructure (such as an enterprise network) to allow one network infrastructure (such as the enterprise) to monitor another network (such as carrier small cells).

Additional features and advantages are described herein, and will be apparent from, the following detailed description and the figures.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a diagrammatic view of network hierarchy from a mobile carrier's serving office to an enterprise network access device (ex: WiFi access point or small cell).

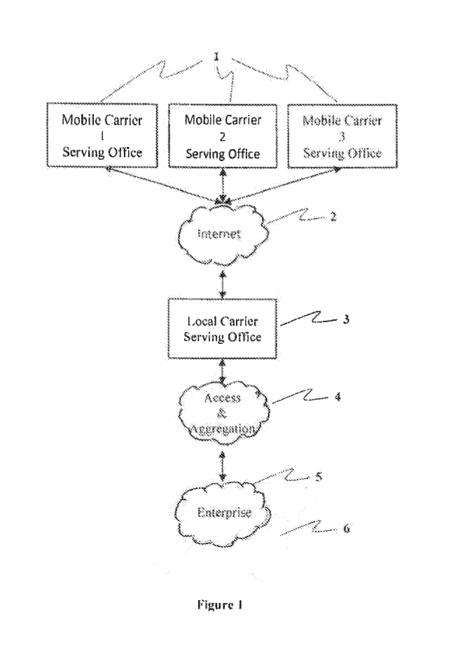

FIG. 2 is a diagrammatic view of the enterprise network hierarchy with the inclusion of the apparatus implemented in an intermediate apparatus and supporting directly attached wireless small cells.

FIG. 3 is a conceptual view of apparatus providing network connectivity and power connectivity from an enterprise to a multiplicity of carrier small cells.

FIG. 4 is a block diagram of apparatus with small cell network interconnection over copper facilities.

### DETAILED DESCRIPTION

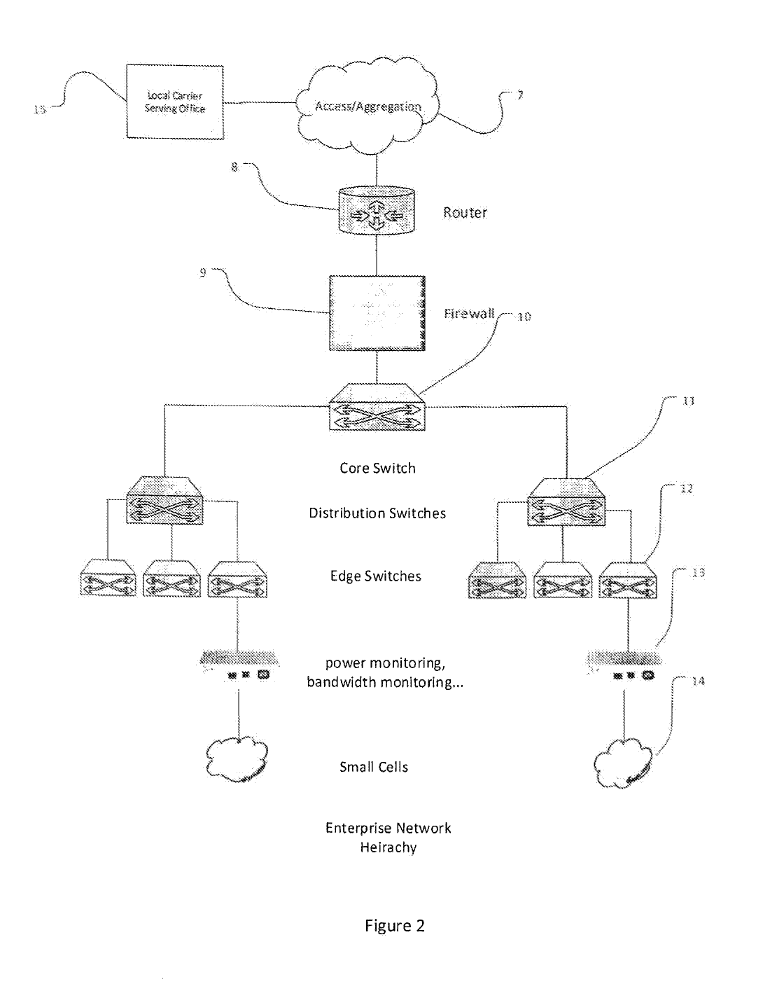

The present invention provides a method and apparatus (13) for providing business level demarcation between small cells deployed in third party facilities (such as an enterprise). FIG. 2 depicts the prototypical enterprise network hierarchy with the incorporation of the apparatus (13). An access/aggregation network 7 provides connectivity to the local serving office 15. An edge router 8 provides IP domain demarcation between the enterprise network and the carrier network. A firewall 9 is used to prevent unauthorized access from the external network to the enterprise network or from unauthorized applications within the enterprise network to the external network. A hierarchy of switches (core 10, distribution 11 and edge 12) provides layer 2 connectivity to users and access devices. The apparatus 13 is positioned between the enterprise network and the small cells 14.

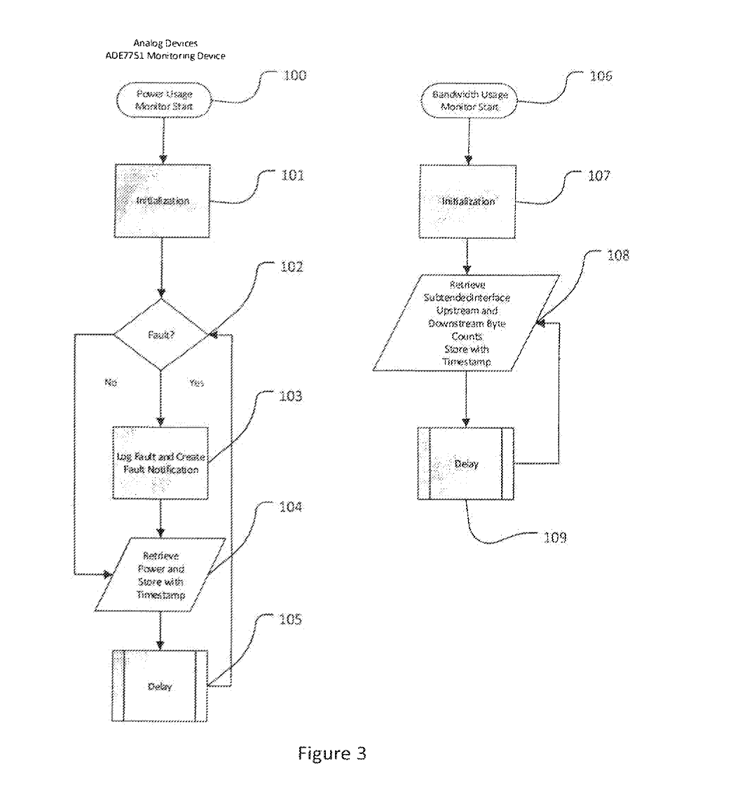

FIG. 3 is a flow chart showing the control flow for measuring the power and bandwidth of each subtended device (such as a small cell). By way of example, it is assumed that the power measurement circuitry employs an ADE7751 Energy Metering IC (made by Analog Devices) per subtended device. The ADE7751 is a highly accurate and fault-tolerant electrical energy measurement IC that is intended for use with 2 wire distribution systems. The ADE7751 incorporates a novel fault detection scheme that warns of a fault condition and allows the ADE7751 to continue compiling accurate billing information even during the fault period. The ADE7751 calculates real power from the instantaneous power signal. The instantaneous power signal is generated by a direct multiplication of the current and voltage signals. This is low pass filtered and passed to a digital-to-frequency converter where it is accumulated over time to create an output frequency that is proportional to the average real power. This can be used to drive a counter which can be polled to get a count per unit time representing power.

FIG. 3 shows the control flow for the power monitoring and measurement function. The process starts at the entry point 100 and progresses through initialization 101. The initialization 101 will place all counters, registers and monitors in a default state. Billing information is historical and will not be reset by the initialization sequence. A fault check 102 determines whether the subtended device is in a fault state (a fault is flagged when the current on the power feed and the neutral differ by more than 12.5% or if the power count has not increased since the previous polling interval). In the event of a power fault, the fault is logged and the apparatus executes a notification sequence 103. After the notification sequence 103 completes or if there is no power fault found, the control sequence will proceed to retrieve the power count and store that count with a timestamp in nonvolatile memory. The counter can be designed to reset the count when it is polled to avoid counter rollovers. For billing purposes, fees are calculated for power usage over unit time and this can be reconstructed from the sequence of power measurements with the associated timestamps. A delay 105 is imposed and the sequence returns to check for faults 102 once again.

FIG. 3 shows the control flow for bandwidth measurements. The process starts at entry point 106 and progresses through initialization 107. The initialization 107 will place all counters, registers and monitors in a default state. Billing information is historical and will not be reset by the initialization sequence. The byte count registers are polled for the upstream and downstream counts for each of the attached device interfaces (ex: small cells). This provides a count of the byte traffic (and by association bit traffic) that is being injected into the supporting network (ex: enterprise) and retrieved from the supporting network (ex: enterprise). The byte counts are stored with timestamps. The bandwidth usage per unit time can be calculated by subtracting the byte counts and time stamps of sequential measurements. Billing can be based upon either overall data passed or aggregate bandwidth. Policing and shaping can operate in conjunction with the bandwidth metering process. The sequence progresses to a delay 109 and then returns to polling 108. It is possible as an alternative to measure byte counts on sub-channels such as EVCs (Ethernet Virtual Circuits) in order to bill on a particular set of traffic rather than the composite set of traffic.

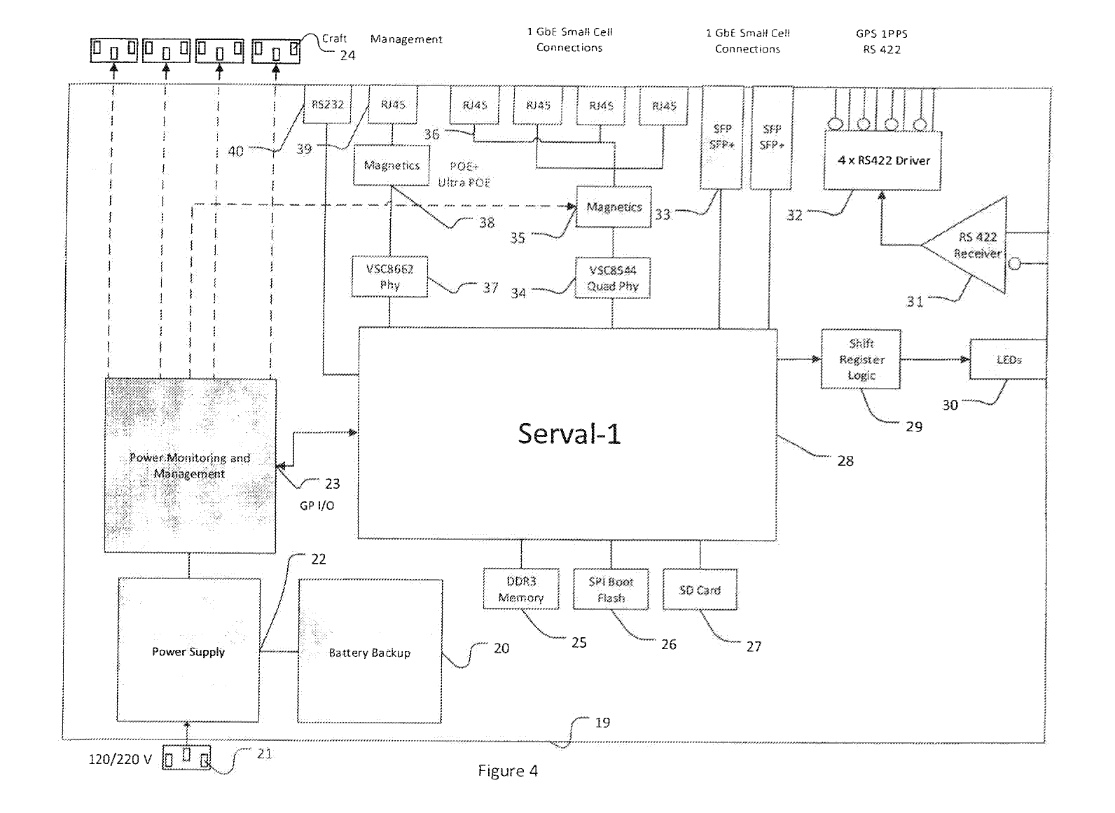

FIG. 4 is a block level diagram of the apparatus (13) that uses copper based facilities to connect to the attached access devices (ex: small cells). In this implementation of the apparatus, the up to four attached small cells can be supported. The small cells can be from one or more carriers.

Power is provided to the apparatus 19 from AC facilities 21. A power supply 22 provides line conditioning for ac power that is fed through the apparatus and converts power to dc for internal use. A battery subsystem 20 connects to the power supply to keep the apparatus active in the event that there is an AC failure on the primary 21 and the network is still active thus allowing the apparatus to report the failure. In this application, power is disconnected to the small cells as the drain is significant. In a modified version of the apparatus a larger battery could be used internally or externally to provide a period of backup to both the apparatus and the small cells in the event of a local primary outage.

The power monitoring and management module 23 is responsible for monitoring and measuring the power provided to each small cell; it provides either AC power or DC power to support POE, POE+ or Ultra POE. The power monitoring and management module 23 will maintain a running measurement of power that can be used by the Serval-1 28 to calculate overall power usage and create billing information as described previously. In addition, the power monitoring and management module 23 is responsible for monitoring the health of the power distribution to the small cells as previously described.

The Serval-1 28 is a commodity chip from Vitesse Semiconductor Corporation. The Serval-1 28 is essentially an Ethernet switch with an integrated MIPs processing core. It has support for a number of carrier Ethernet monitoring and performance assurance features including IEEE 802.1ag/Y.1731, IEEE 802.3ah and RFC 2544. The purpose of the Serval-1 28 is multifold. It is the central processor for the apparatus; the MIPs engine runs local code. It provides the accounting function for power and bandwidth usage in order to create billing information; it is responsible for monitoring power health, network health and health of the apparatus. The Serval-1 28 uses several associated memory subsystems that reside on the apparatus. A RAM based memory subsection 25 provides local volatile storage, an SPI Boot Flash 26 provides system initialization, and executable code resides on the SD Card 27. The Serval-1 28 has embedded logic to support indicators 30 and interface with subsystems such as the Power Monitoring and Management 23 subsystem. The Serval-1 28 is capable of implementing strong encryption which is critical to managing sensitive business information. In many cases, businesses have a legal responsibility to protect information and in a wireless network run by a third party control of that information is lost. As such, strong encryption insures that even if the information is carried over unsecured facilities, it will be protected against unauthorized access.

Small cells require access to network timing. There are several mechanisms to implement this including GPS based timing, IEEE 1588, or network listening mode. IEEE 1588 uses coded packets to convey timing and the target device constructs timing from the Ethernet coded packets. An optional refinement (not shown) is to put a Stratum timing module in the apparatus to provide localized correction to compensate for delay variations associated with the overall Ethernet timing distribution. Most carriers prefer GPS derived timing as the primary timing mechanism and IEEE 1588 as a secondary timing mechanism. The apparatus 19 is shown with a distribution circuit to provide PPS timing from a GPS derived source to a multiplicity of subtended small cells. An RS422 receiver 31 provides regeneration of the received differential signal and a RS422 quad driver 32 provides replicated copies for the subtended small cells.

The apparatus 19 provides aggregation of Ethernet/IP traffic to and from the subtended small cells. Traffic is aggregated onto one or more network facing ports. In an embodiment, the network ports are implemented optically and utilize small form factor pluggable modules 33. The Ethernet ports connecting the subtended small cells utilize copper facilities (ex: category 5 or category 6 cable) and the interface electronics are shown. A quad phy 34 is used to provide the correct media level interface. The device shown is a commodity device from Vitesse Semiconductor Corporation. Magnetics 35 provide line isolation and the means to inject DC power onto the copper facilities. The means to implement this should be well known to someone versed in the arts. Ultra POE can supply up to 51 W and is based upon the IEEE 802.3at-2009 standard. Ultra POE and POE+ detect a signature resistor at the destination to determine the power level. It is possible to power devices in excess of 51 W provided the cable length is reduced from the maximum 100 meters specified by IEEE 802.3at-2009 as dissipation in the cable tends to be limiting. In this application, the apparatus 19 can be located in the region of the small cells minimizing the necessary cable lengths and providing higher levels of delivered power (if necessary).

Several management paths are provided to create management connectivity to the apparatus 19. An in-band management path supports an IP/Ethernet path that is terminated on the MIPs processor within the Serval-1 28. In addition, an out-of-band Ethernet path allows a direct connection to the apparatus 19 as implemented by the phy 37, the magnetics 38 and the RJ45 connector 39. An RS232 interface is provided by the Serval-1 28 internal logic and the RJ45 connector 40. The RS232 interface is provided to support a direct serial connection to the apparatus to support a command line interface (CLI). CLIs are typically used as a troubleshooting interface. The Ethernet management path allows management to be done out-of-band. In some deployments, an out-of band-path is preferred as it can be implemented separate from the customer data and is often more secure.

With respect to the foregoing embodiments, various modified examples are conceivable within the scope of the invention. Besides, various modified examples and applied examples created or combined based on the recitation of the specification are also conceivable. It should be understood by those skilled in the art that various modifications, combinations, sub-combinations and alterations may occur depending on design requirements and other factors. It should be understood that various changes and modifications to the presently preferred embodiments described herein will be apparent to those skilled in the art. Such changes and modifications can be made without departing from the spirit and scope of the present subject matter and without diminishing its intended advantages.

We claim:

1. A method for a primary network to monitor and charge for power consumption and bandwidth usage of a connected secondary network, comprising:
retrieving and storing at a computational device a power count information measured by a power monitoring and management device comprising the computational device, the power count representing power utilized by the secondary network and the computational device operating as an interface between the primary and secondary networks;
polling an upstream byte count register comprising the computational device for an upstream byte count information from the secondary network to the primary network, and polling a downstream byte count register comprising the computational device for a downstream byte count information from the primary network to the secondary network; and
using the power count information and the upstream and downstream byte count information to calculate a cost to the secondary network for utilization of the primary network power and bandwidth resources.
